(19) United States
(12) Patent Application Publication
(10) Pub. No.: US 2017/0311414 A1
(43) Pub. Date: Oct. 26, 2017

(54) LIGHTING SYSTEM AND LIGHTING DEVICE

(71) Applicant: Panasonic Intellectual Property Management Co., Ltd,, Osaka (JP)

(72) Inventors: Shojiro KIDO, Osaka (JP); Akihiro KISHIMOTO, Osaka (JP)

(21) Appl. No.: 15/492,763

(22) Filed: Apr. 20, 2017

(30) Foreign Application Priority Data
Apr. 25, 2016 (JP) 2016-087570

(51) Int. Cl. H05B 37/02; A01G 7/04

(52) U.S. Cl. CPC H05B 37/0227; H05B 37/0281; A01G 7/045; H05B 37/0272

(57) ABSTRACT

Provided is a lighting system that illuminates an object with illumination light. The lighting system includes a radio frequency (RF) tag and a lighting device. The RF tag is directly attached to the object or assigned to the object and stores attribute information on the object. The lighting device illuminates the object with the illumination light and includes a light source, a communication circuit, and a controller. The light source emits the illumination light. The communication circuit includes an RF tag reader that wirelessly reads the attribute information stored in the RF tag. The controller controls at least one of dimming, a color, and an emission time of the illumination light emitted by the light source, based on the attribute information read from the RF tag by the RF tag reader.

### CROSS REFERENCE TO RELATED APPLICATION

This application claims the benefit of priority of Japanese Patent Application Number 2016-087570 filed on Apr. 25, 2016, the entire content of which is hereby incorporated by reference.

### BACKGROUND

### 1. Technical Field

The present disclosure relates to a lighting system and a lighting device that illuminate an object, such as a plant or garment, with appropriate illumination light.

### 2. Description of the Related Art

Conventionally, various lighting systems for illuminating a plant with appropriate illumination light for growing the plant or illuminating a displayed product, such as a garment, with appropriate illumination light for enhancing the presentation of the product have been proposed (for example, see Japanese Unexamined Patent Application Publication No. 2015-022989 and Japanese Unexamined Patent Application Publication No. 2008-270089).

According to Japanese Unexamined Patent Application Publication No. 2015-022989, a lighting device includes a light-emitting unit that emits light which induces a photoreaction in a plant, and as such, an efficient photoreaction occurs in the plant.

Further, according to Japanese Unexamined Patent Application Publication No. 2008-270089, troublesome adjustment of illumination light is obviated by use of a remote control for changing settings to read color or material information from an information tag attached to a product, such as a garment, and transmit the color or material information to a lighting device to change, for example, the color of the illumination light.

### SUMMARY

However, there is a problem with the technique disclosed in Japanese Unexamined Patent Application Publication No. 2015-022989 in that the technique cannot be applied when the location of the plant is changed for the purpose of, for example, changing the growing temperature. In other words, when the locations of plants are changed and the type of plant illuminated by the illumination light from the same lighting device is different, troublesome adjustments must be made since a lighting condition (color, dimming, emission time of light, etc.) of the lighting device must be changed to accommodate the new type of plant.

Further, with the technique disclosed in Japanese Unexamined Patent Application Publication No. 2008-270089, aspects of the lighting device to be adjusted are determined based on an information tag attached to the product, but color or material information must be read and transmitted to the lighting device using the remote control each time the product illuminated by the lighting device is changed, which is time consuming.

In view of this, the present disclosure has been conceived in order to overcome the above problems, and has an object to provide a lighting system and a lighting device capable of illuminating an object with illumination light appropriate for the object, without requiring manual labor even when the location of the object is changed.

In order to achieve the above object, a lighting system according to one aspect of the present disclosure illuminates an object with illumination light and includes a radio frequency (RF) tag and a lighting device. The RF tag is directly attached to the object or assigned to the object and stores attribute information on the object. The lighting device illuminates the object with the illumination light and includes a light source, a communication circuit, and a controller. The light source emits the illumination light. The communication circuit includes an RF tag reader that wirelessly reads the attribute information stored in the RF tag. The controller controls at least one of dimming, a color, and an emission time of the illumination light emitted by the light source, based on the attribute information read from the RF tag by the RF tag reader.

Moreover, a lighting device that illuminates an object with illumination light includes: a light source that emits the illumination light; a communication circuit including an RF tag reader that wirelessly reads attribute information stored in an RF tag assigned to the object; and a controller that controls at least one of dimming, a color, and an emission time of the illumination light emitted by the light source, based on the attribute information read from the RF tag by the RF tag reader. The light source illuminates the object with the illumination light with the at least one of dimming, a color, and an emission time controlled by the controller.

Accordingly, the lighting system and lighting device according to the present disclosure illuminate an object with illumination light appropriate for the object, without requiring manual labor even when the location of the object is changed.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a block diagram illustrating a configuration of a lighting system according to Embodiment 1;

FIG. 2 illustrates an example in which the lighting system illustrated in FIG. 1 is used in an agricultural factory;

FIG. 3 illustrates an example of a flow of processes for growing plants using the lighting system illustrated in FIG. 1;

FIG. 4 illustrates an example of a lighting pattern table stored in advance in the controller illustrated in FIG. 1;

FIG. 5 is a flow chart illustrating operations performed by a lighting system according to Embodiment 1;

FIG. 6 is a block diagram illustrating a configuration of a lighting system according to a variation of Embodiment 1;

FIG. 7 is a block diagram illustrating a configuration of a lighting system according to Embodiment 2;

FIG. 8 illustrates an example in which the lighting system illustrated in FIG. 7 is installed in a store;

FIG. 9 is a flow chart illustrating operations performed by the lighting system according to Embodiment 2; and

FIG. 10 is an external view of a lighting device in which a light source and a communication circuit (RF tag reader and RF tag writer) are disposed one on top of the other.

### DETAILED DESCRIPTION OF THE EMBODIMENTS

The following describes embodiments with reference to the drawings. Note that the embodiments described below each show a specific example of the present disclosure. The numerical values, shapes, materials, elements, the arrangement and connection of the elements, steps, order of the steps, etc., indicated in the following embodiments are mere examples, and therefore do not intend to limit the inventive concept. Therefore, among elements in the following embodiments, those not recited in any of the independent claims defining the most generic part of the inventive concept are described as optional elements.

### Embodiment 1

First, lighting system 10 according to Embodiment 1, which is used for growing plants, will be described.

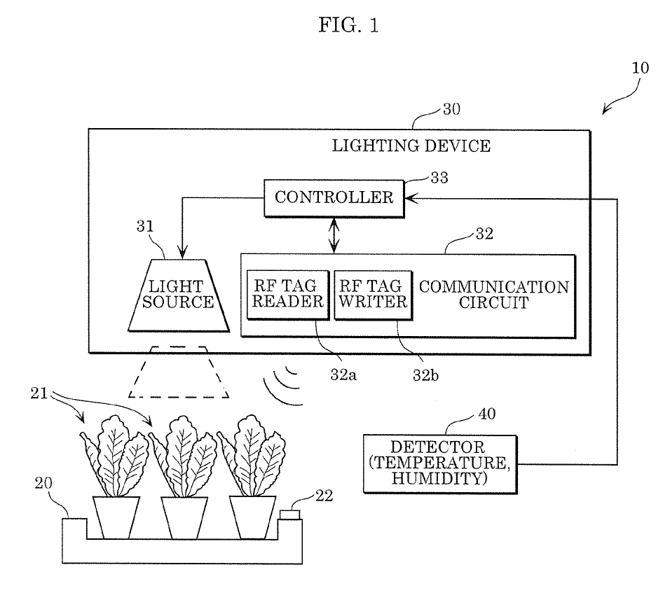

FIG. 1 is a block diagram illustrating a configuration of lighting system 10 according to Embodiment 1.

Lighting system 10 illuminates an object (here, plant 21) with illumination light, and includes RF tag 22, lighting device 30, and detector 40. According to this embodiment, the object is exemplified as plant 21 placed on palette 20, and lighting system 10 automatically illuminates plant 21 with illumination light to grow plant 21.

RF tag 22 is a radio frequency identification (RFID) IC tag attached directly to the object or assigned to the object (here, the object is plant 21 and the RFID IC tag is attached to palette 20 on which plant 21 is placed). RF tag 22 is, for example, a passive tag, and operates using radio waves from RF tag reader 32a and RF tag writer 32b as a source of energy. RF tag 22 includes internal memory that information is read from and written to via wireless communication with RF tag reader 32a and RF tag writer 32b included in communication circuit 32 of lighting device 30. The memory stores attribute information on the object (here, plant 21) placed on palette 20 to which RF tag 22 is attached. In this embodiment, the attribute information includes at least information indicating the type of plant 21 placed on palette 20 attached with RF tag 22.

Detector 40 is a sensor that detects at least one of the temperature and the humidity of the environment in which plant 21 is placed, and is, for example, a sensor that measures both the temperature and the humidity.

Lighting device 30 illuminates plant 21 with illumination light and includes light source 31, communication circuit 32, and controller 33.

Light source 31 emits illumination light under control by controller 33, and, for example, includes a light-emitting component (e.g., LED, fluorescent light, light bulb) capable of changing the color and dimming of emitted light in accordance with the electric circuit and the current output from the electric circuit.

Communication circuit 32 includes RF tag reader 32a that reads information, such as attribute information stored in RF tag 22, and RF tag writer 32b that writes information to RF tag 22.

Controller 33 is a circuit that controls light source 31 and communication circuit 32 by communicating (sending and/or receiving information) with light source 31, communication circuit 32, and detector 40. Controller 33 is realized by, for example, a microcomputer including, for example, an input/output port that communicates with, for example, ROM storing a program, RAM storing data, a processor executing a program, a calendar/timer, and/or a peripheral circuit.

More specifically, in functional terms, controller 33 controls at least one of the dimming, the color, and the emission time of the illumination light emitted by light source 31, based on the attribute information read from RF tag 22 via RF tag reader 32a. In other words, the attribute information is one example of control information (i.e., a control recipe) that determines conditions (i.e., an illumination recipe) for the illumination light. Moreover, controller 33 obtains and writes related information relating to the conditions in which plant 21 is placed to RF tag 22 via RF tag writer 32b. More specifically, controller 33 writes information specifying at least one of the dimming, the color, and the emission time of the illumination light illuminating plant 21 to RF tag 22 as the related information. Further, controller 33 writes information indicating at least one of the temperature and the humidity detected by detector 40 to RF tag 22 as the related information.

Controller 33 reads, via RF tag reader 32a, the attribute information and the related information stored in RF tag 22, and based on the read attribute information and related information, controls at least one of the dimming, the color, and the emission time of the illumination light emitted by light source 31. Here, controller 33 can cause light source 31 to emit illumination light predetermined as stage lighting or illumination light predetermined as biological reaction lighting (lighting that facilitates growth of a plant), based on at least the attribute information. More specifically, controller 33 can cause light source 31 to emit the illumination light in one lighting pattern selected from among a plurality of predetermined lighting patterns defined by a time variation of at least one of the dimming and the color, based on at least the attribute information. For example, controller 33 can cause light source 31 to emit illumination light having a high color temperature to facilitate photosynthesis during the vegetative state of the plant, and emit illumination light having a low color temperature during the flowering stage of the plant.

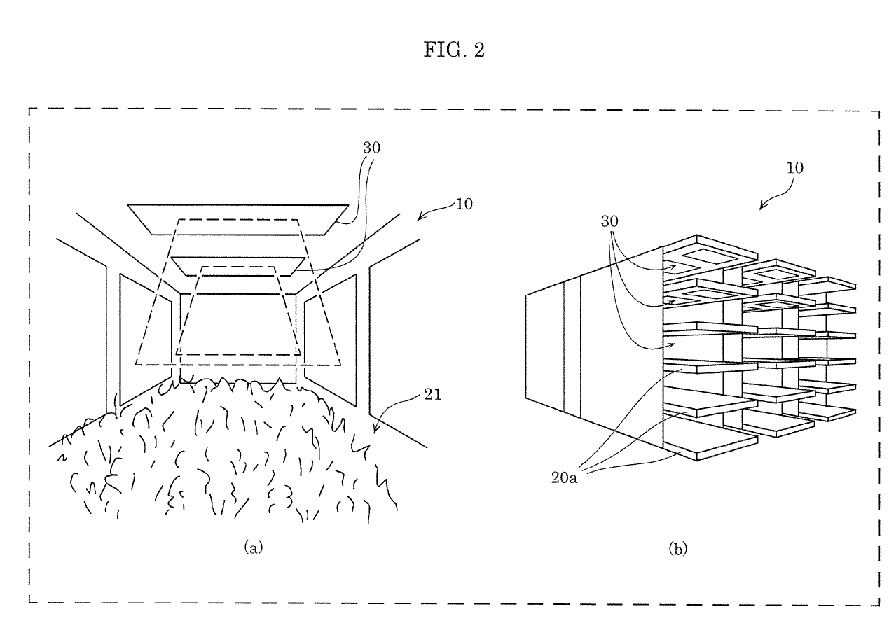

FIG. 2 illustrates an example in which lighting system 10 illustrated in FIG. 1 is used in an agricultural factory.

In FIG. 2, (a) illustrates a bed of plants 21 configured of a plurality of seedlings placed on palettes (not illustrated) arranged in a matrix so as to blanket the surface in a room in which a plurality of lighting devices 30 are disposed. Moreover, in FIG. 2, (b) illustrates multi-level cultivation shelves 20a on which the plant 21 seedlings are placed. Cultivation shelves 20a are used as palettes on which a plant 21 seedling is placed and, alternatively, are used as shelves for placing palettes on which a plurality of plant 21 seedlings are placed. Lighting devices 30 are disposed above each level of cultivation shelves 20a and illuminate the seedlings placed on the level below with illumination light.

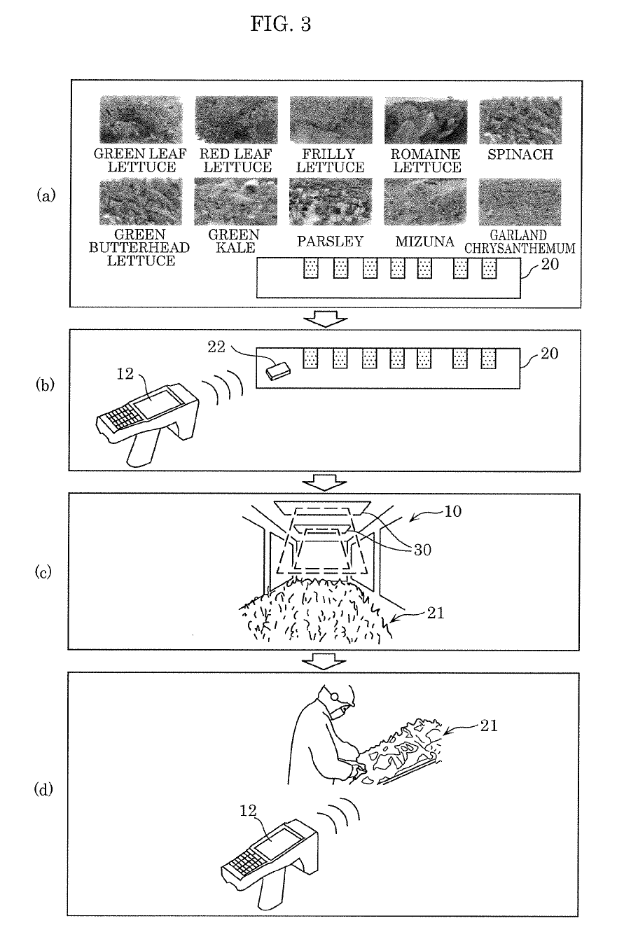

FIG. 3 illustrates an example of a flow of processes for growing plants using lighting system 10 illustrated in FIG. 1.

First, as illustrated in (a) in FIG. 3, a grower grows a variety of plants by planting the plants on a per palette 20 (i.e., per bed) basis such that each palette 20 is planted with a single type of plant.

Then, as illustrated in (b) in FIG. 3, RF tag 22 is attached to each palette 20, and using RF tag reader/writer 12, information related to the planting of plant 21 on palette 20 (information on the type of plant 21 and when plant 21 was planted) is written to RF tag 22 as the attribute information.

Next, as illustrated in (c) in FIG. 3, all palettes 20 for which writing of the attribute information is complete are arranged in the agricultural factory in which lighting devices 30 are installed. Note that in each lighting device 30 installed in agricultural factory controller 33 repeats, in a regular cycle, the reading of the attribute information from RF tag 22 via RF tag reader 32a. With this, controller 33 monitors whether a new palette 20 attached with RF tag 22 is placed beneath lighting device 30.

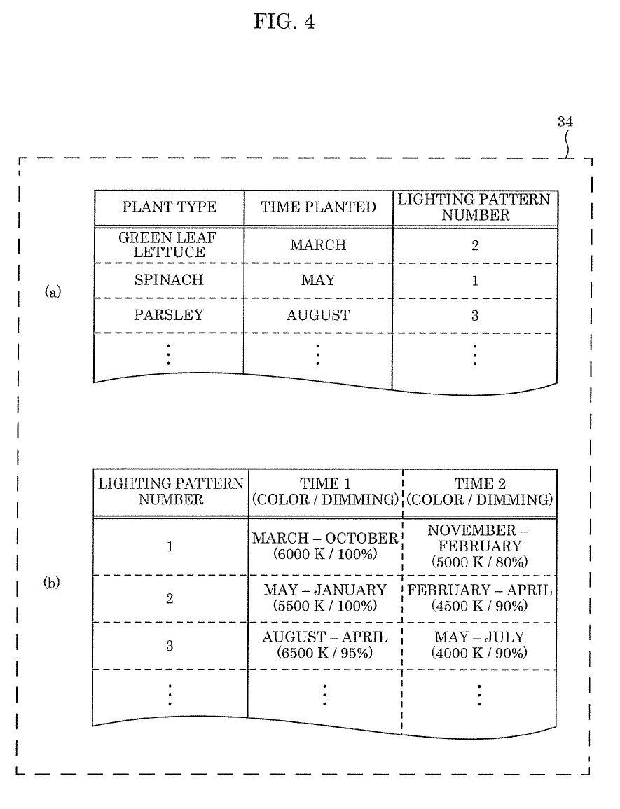

When a new palette 20 is placed beneath lighting device 30, controller 33 reads the attribute information (information on the type of the plant and when the plant was planted) from RF tag 22 attached to palette 20. Controller 33 then compares the read attribute information with an internally stored lighting pattern table 34, such as the table illustrated in FIG. 4, selects a lighting pattern corresponding to the attribute information, and causes light source 31 to emit illumination light in the selected lighting pattern. FIG. 4 illustrates an example of lighting pattern table 34 stored in advance in controller 33. The lighting pattern table includes a table in which attribute information (information on the type of the plant and when the plant was planted) is associated with lighting pattern numbers ((a) in FIG. 4), and a table in which lighting pattern numbers are associated with details regarding the lighting pattern (a time variation of at least one of dimming and color of light) ((b) in FIG. 4). Controller 33 refers to the table illustrated in (a) in FIG. 4 to identify the lighting pattern number that matches the attribute information (information on the type of the plant and when the plant was planted) read from RF tag 22. Controller 33 then refers to the table illustrated in (b) in FIG. 4 to identify the lighting pattern that corresponds to the identified lighting pattern number (the time of year the plant should be planted, the color, and the dimming that corresponds to the identified lighting pattern number), and causes light source 31 to emit illumination light in the identified lighting pattern. For example, when the attribute information read from RF tag 22 indicates “green leaf lettuce” as the “plant type” and “March” as the “time planted,” controller 33 performs lighting control corresponding to the lighting pattern number “1.” In other words, controller 33 refers to an internal calendar/timer and causes light source 31 to emit light having a color of 6000K and a dimming rate of 100% (i.e., not dimmed so as to output light at 100%) from March through October, and causes light source 31 to emit light having a color of 5000K and a dimming rate of 80% (i.e., dimmed to 80% light output) from November through February.

Further, as illustrated in (c) in FIG. 3, during the growing of plant 21, controller 33 writes related information relating to the conditions in which plant 21 is placed to RF tag 22 via RF tag writer 32b. More specifically, controller 33 writes information specifying at least one of the dimming, the color, and the emission time of the illumination light illuminating plant 21 and information indicating at least one of the temperature and the humidity detected by detector 40 to RF tag 22 as the related information. For example, once a day, controller 33 writes the dimming, the color, the emission time, the temperature (the highest temperature for the day, the lowest temperature for the day, or the average temperature for the day), and the humidity (the highest humidity for the day, the lowest humidity for the day, or the average humidity for the day) of the emitted illumination light to RF tag 22 as the related information.

Lastly, as illustrated in (d) in FIG. 3, when plant 21 is fully grown or when growing information is read from plant 21, the grower uses RF tag reader/writer 12 to read the attribute information and the related information stored in RF tag 22. Then, the grower utilizes the read attribute information and related information for planning for the next growing iteration by associating growing conditions specified by the attribute information and the related information read from RF tag 22 with the actual growth state of plant 21 and accumulating and analyzing the data as, for example, “big data.”

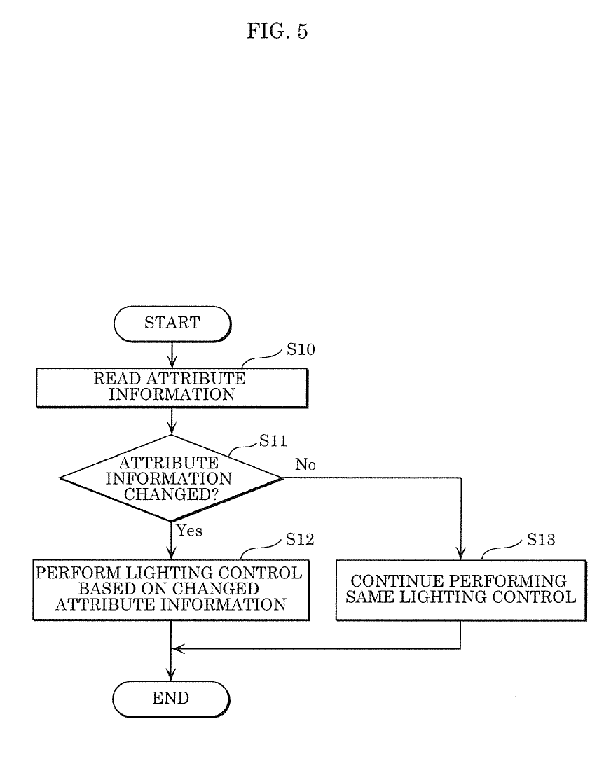

Note that while the plants are being grown, as illustrated in (c) in FIG. 3, when palette 20 placed beneath lighting device 30 is changed, the illumination light emitted from lighting device 30 automatically changes to illumination light suitable for plant 21 placed on the changed palette 20. FIG. 5 is a flow chart illustrating operations performed by lighting system 10 (more specifically, controller 33 of lighting device 30) when palette 20 placed beneath lighting device 30 is changed. Controller 33 repeats, in a regular cycle (for example, once a day), the reading of the attribute information from RF tag 22 via RF tag reader 32a (S10). Then, controller 33 determines whether the attribute information just read and the attribute information previously read match to determine whether the attribute information has changed, i.e., whether palette 20 placed beneath lighting device 30 has changed (S11). When, as a result, controller 33 determines that the attribute information has changed (yes in S11), controller 33 refers to lighting pattern table 34, selects a lighting pattern corresponding to the changed attribute information, and causes light source 31 to emit illumination light in the selected lighting pattern (S12). However, when controller 33 determines that the attribute information has not changed (no in S11), controller 33 continues performing the same lighting control (S13).

As described above, lighting system 10 according to this embodiment illuminates an object (here, plant 21 or a seedling of plant 21) with illumination light and includes RF tag 22 and lighting device 30. RF tag 22 is directly attached to the object or assigned to the object and stores attribute information on the object. Lighting device 30 illuminates the object with the illumination light and includes light source 31, communication circuit 32, and controller 33. Light source 31 emits the illumination light. Communication circuit 32 includes RF tag reader 32a that reads the attribute information stored in RF tag 22. Controller 33 controls at least one of the dimming, the color, and the emission time of the illumination light emitted by light source 31, based on the attribute information read from RF tag 22 via RF tag reader 32a.

With this, the attribute information on the object stored in RF tag 22 attached to the object is read by RF tag reader 32a included in lighting device 30, and the illumination light emitted by light source 31 in lighting device 30 is controlled based on the attribute information read by RF tag reader 32a. Therefore, even when one object is replaced with another object for the purpose of, for example, changing the growing temperature, illumination light suitable for the newly placed object is automatically selected and emitted.

Moreover, since the illumination light is adjusted by the attribute information being read by RF tag reader 32a included in lighting device 30 without the use of, for example, a remote control, adjusting the illumination light is not time consuming. As a result, even when one object is replaced with another object, lighting system 10 can illuminate the object with illumination light appropriate for the object, without requiring manual labor.

Further, an RF tag, which can be read over radio waves unlike labels such as a barcode or QR code (R), which are read with light, is used as the storage medium in which the attribute information is stored. Therefore, even when the storage medium is obscured by, for example, leaves of a plant, the attribute information can be read by lighting device 30 with certainty and without difficulty.

Communication circuit 32 further includes RF tag writer 32b that writes information to RF tag 22. Controller 33 writes related information relating to the conditions in which the object is placed to RF tag 22 via RF tag writer 32b. Note that communication circuit 32 need not write all related information to RF tag 22; communication circuit 32 may record only the ID to RF tag 22 and may store the remaining related information in a server connected over a communications network. In this case, when communication circuit 32 reads the related information, communication circuit 32 may read the ID from RF tag 22 and read the remaining related information from the server.

With this, related information relating to the conditions in which the object is placed is written to RF tag 22 attached to the object via RF tag writer 32b included in lighting device 30. Thus, the conditions in which the object is placed are recorded in RF tag 22 as a history, whereby the relation between the conditions in which the object is placed and the state of the object (growth state, whether it is sold or not, etc.) can be analyzed.

Moreover, controller 33 writes information specifying at least one of the dimming, the color, and the emission time of the illumination light illuminating the object to RF tag 22 as the related information.

With this, the information specifying at least one of the dimming, the color, and the emission time of the illumination light illuminating the object is written to RF tag 22. Thus, aspects of the illumination light received by the object are recorded in RF tag 22 as a history, whereby the relation between the aspects of the illumination light received by the object and the state of the object (growth state, whether it is sold or not, etc.) can be analyzed.

Moreover, lighting system 10 further includes detector 40 that detects at least one of the temperature and the humidity of an environment in which the object is placed. Controller 33 writes information indicating at least one of the temperature and the humidity detected by detector 40 to RF tag 22 as the related information.

With this, information indicating at least one of the temperature and the humidity of an environment in which the object is placed is written to RF tag 22. Thus, the environment in which the object is placed is recorded in RF tag 22 as a history, whereby the relation between the environment in which the object is placed and the state of the object (growth state, whether it is sold or not, etc.) can be analyzed.

Moreover, controller 33 causes light source 31 to emit illumination light predetermined as stage lighting or illumination light predetermined as biological reaction lighting, based on at least the attribute information.

With this, stage lighting or biological reaction lighting is performed based on the attribute information stored in RF tag 22 attached to the object, whereby lighting suitable for displaying a product or lighting suitable for growing a living being such as a plant are performed.

Moreover, controller 33 causes light source 31 to emit the illumination light in one lighting pattern selected from among a plurality of predetermined lighting patterns defined by a time variation of at least one of the dimming and the color, based on at least the attribute information.

With this, lighting according to an appropriate lighting pattern selected taking into account the elapse of time is performed based on the attribute information stored in RF tag 22 attached to the object.

Note that in this embodiment, the related information written to RF tag 22 during the growing of plant 21 is exemplified as being utilized for planning for the next growing iteration, but how the related information is utilized is not limited to this example; the related information may be utilized for controlling the lighting. In other words, controller 33 reads, via RF tag reader 32a, the attribute information and the related information stored in RF tag 22, and based on the read attribute information and related information, controls at least one of the dimming, the color, and the emission time of the illumination light emitted by light source 31. For example, controller 33 may refer to information indicating past temperature included in the related information read from RF tag 22 and cause light source 31 to increase the dimming rate of the illumination light (i.e., increase light output) when controller 33 detects that the number of days colder than the average year exceeds a certain number of days.

With this, since the illumination light is controlled based on related information written after the fact in addition to attribute information stored in advance in RF tag 22, lighting can be dynamically controlled in accordance with various information written after the fact in RF tag 22.

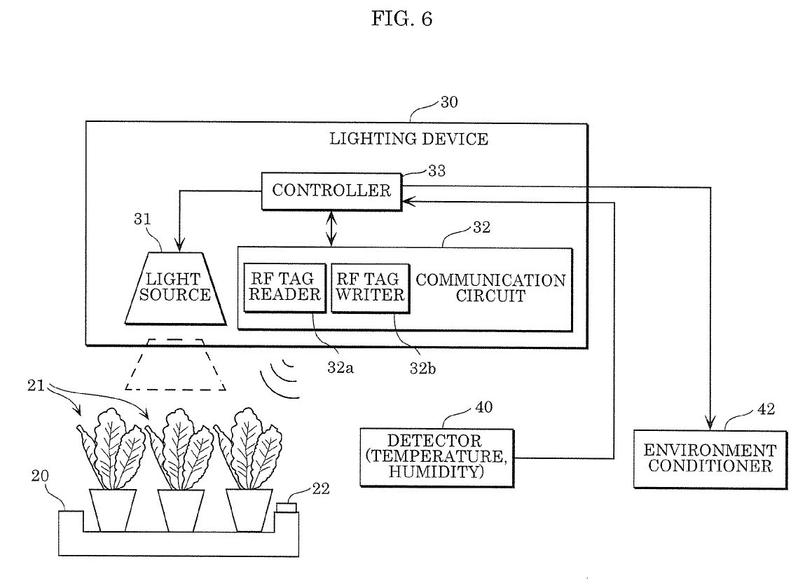

Note that as illustrated in FIG. 6, lighting system 10 according to Embodiment 1 may include environment conditioner 42 that conditions the environment in which the object is placed. FIG. 6 is a block diagram illustrating a configuration of a lighting system according to such a variation of Embodiment 1. Here, illustrated is a lighting system according to a variation of Embodiment 1 equivalent to lighting system 10 illustrated in FIG. 1 additionally includes environment conditioner 42.

Environment conditioner 42 is a device that conditions the environment (for example, at least one of the surrounding temperature, the surrounding humidity, the amount or concentration of water or a nutrient applied to the object) in which an object is placed, and is, for example, an air conditioner, a sprinkler, or water or nutrient supplier. Controller 33 controls the environment in which the object is placed by controlling environment conditioner 42 based on the attribute information read from RF tag 22 and/or the temperature and the humidity detected by detector 40 (or the related information). For example, when the attribute information includes environment information indicating a target temperature and a target humidity, controller 33 controls environment conditioner 42 such that the temperature and humidity detected by detector 40 reach the target temperature and the target humidity indicated in the environment information, respectively.

With this, lighting system maintains a more suitable environment for, for example, growing or displaying an object since the environment in which the object is placed (surrounding temperature and surrounding humidity, for example) is conditioned in addition to the illumination light illuminating the object.

Moreover, lighting system 10 or lighting device 30 according to Embodiment 1 may include a camera for capturing an image of plant 21, and may capture an image of plant 21 with the camera as plant 21 grows and write the captured image to a corresponding RF tag 22 as related information. This makes it possible to record detailed information on the state of the growth of plant 21 and thus analyze the relation between an aspect of the illumination light received by plant 21 and the growth state of plant 21 at a later time.

Moreover, in Embodiment 1, palette 20 is not limited to the object commonly referred to as a “palette”; palette 20 refers to any object on which plant 21 can be placed or planted. For example, palette 20 may be an object referred to as, for example, a tray, shelf, cart, platform, board, bed, pot, or container.

### Embodiment 2

In Embodiment 1, lighting system 10 is exemplified as being used for growing plants, but the lighting system according to the present disclosure is not limited to this example; the lighting system may be used in an apparel store. Hereinafter, Embodiment 2 in which the lighting system according to the present disclosure is exemplified as being used in an apparel store will be described.

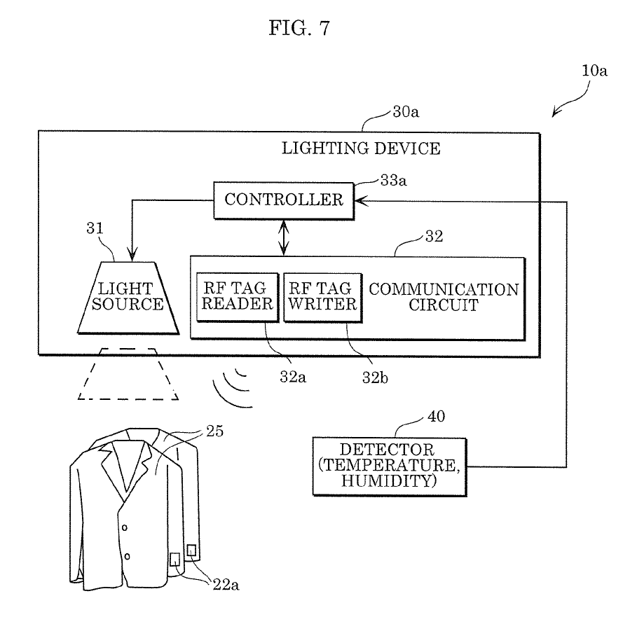

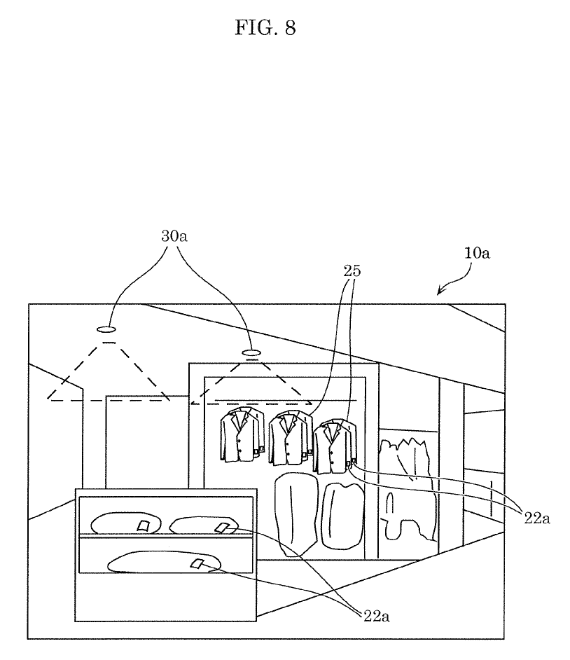

FIG. 7 is a block diagram illustrating a configuration of lighting system 10a according to Embodiment 2 used in an apparel store. FIG. 8 illustrates an example in which lighting system 10a illustrated in FIG. 7 is installed in a store.

Lighting system 10a illuminates an object (here, garment 25) with illumination light, and includes RF tag 22a and lighting device 30a. According to this embodiment, the object is garment 25 displayed in a store, and lighting system 10a automatically illuminates garment 25 with appropriate illumination light for enhancing the presentation of the product. Note that the basic structures of RF tag 22a and lighting device 30a are the same as those of RF tag 22 and lighting device 30 in Embodiment 1, respectively. Hereinafter, elements that are the same as in Embodiment 1 share like reference signs, and description will focus on points of difference with Embodiment 1.

RF tag 22a is an RFID IC tag that is attached to an object or assigned to an object (here, the object is garment 25 and RF tag 22a is attached to garment 25 via a string). RF tag 22a includes internal memory that stores attribute information on the object (here, garment 25) to which RF tag 22a is attached. The attribute information includes at least information indicating a season for which wearing garment 25 attached with RF tag 22a is suitable (for example, “summer garment” or “winter garment”). Note that RF tag 22a may be an anti-theft tag.

Lighting device 30a illuminates garment 25 with illumination light and includes light source 31, communication circuit 32, and controller 33a. Light source 31 and communication circuit 32 are the same as described in Embodiment 1. However, in this embodiment, RF tag reader 32a included in communication circuit 32 includes the function of reading a plurality of RF tags 22a all at once (anti-collision function).

In regard to basic function and hardware configuration, controller 33a is the same as controller 33 according to Embodiment 1. However, in this embodiment, controller 33a reads the attribute information stored in RF tag 22a via RF tag reader 32a, and based on the read attribute information, causes light source 31 to emit illumination light predetermined as stage lighting.

More specifically, controller 33a causes light source 31 to emit illumination light in a color predetermined as a cool color when the attribute information read from RF tag 22a includes information indicating summer (for example, “for summer”) as the season for which wearing garment 25 is suitable. However, when the attribute information read from RF tag 22a includes information indicating winter (for example, “for winter”) as the season for which wearing garment 25 is suitable, controller 33a causes light source 31 to emit illumination light in a color predetermined as a warm color.

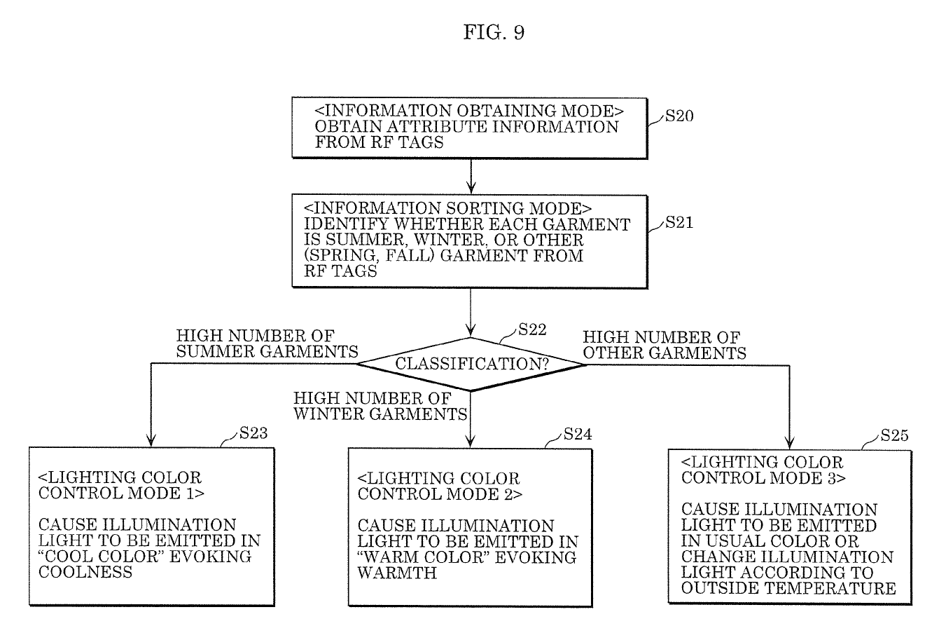

FIG. 9 is a flow chart illustrating operations performed by lighting system 10a according to Embodiment 2. FIG. 9 illustrates a flow chart for operations performed by lighting device 30a when a plurality of garments 25 (each attached with RF tag 22a) are displayed beneath lighting device 30a and at least one garment 25 is replaced with another garment.

Note that in lighting device 30a, similar to Embodiment 1, controller 33a repeats, in a regular cycle, the reading of the attribute information from the plurality of RF tags 22a attached to the plurality of garments 25 via RF tag reader 32a. Then, controller 33a determines whether all attribute information just read and all attribute information previously read match, and when all information does not match, determines that at least one of the plurality of garments 25 has changed, and performs the following.

First, controller 33a reads the attribute information from all RF tags 22a via RF tag reader 32a (information obtaining mode S20). Then, controller 33a refers to information indicating season in the read attribute information, and identifies a classification of each garment 25 as being either a summer garment, a winter garment, or other garment (spring garment, fall garment) (information sorting mode S21).

Next, controller 33a selects a lighting mode in accordance with the identified classification (lighting selection S22), and controls light source 31 in accordance with the selected mode to adjust the illumination light (lighting color control mode 1 (S23) lighting color control mode 2 (S24), lighting color control mode 3 (S25)).

More specifically, in information sorting mode S21, when controller 33a determines that a large number of the garments are summer garments (for example, when the percentage of the garments determined to be summer garments among the identified classifications exceeds a predetermined first percentage) (“high number of summer garments” in response to S22), controller 33a causes (adjusts) light source 31 to emit illumination light in a color predetermined as a cool color that evokes a feeling of coolness (for example, a color having a color temperature exceeding 5000K).

On the other hand, in information sorting mode S21, when controller 33a determines that a large number of the garments are winter garments (for example, when the percentage of the garments determined to be winter garments among the identified classifications exceeds a predetermined percentage) (“high number of winter garments” in response to S22), controller 33a causes (adjusts) light source 31 to emit illumination light in a color predetermined as a warm color that evokes a feeling of warmth (for example, a color having a color temperature of under 4000K).

Further, in information sorting mode 21, when the determination by controller 33a is neither “high number of summer garments” nor “high number of winter garments” (i.e., when the determination is “high number of other garments” in response to S22), controller 33a determines that the current season is fall or spring, and causes (adjusts) light source 31 to emit illumination light in a neutral color tone (for example, a color having a color temperature in a range from 4000K to 5000K). Alternatively, in order to deal with changes in sales of garments due to changes in outdoor temperature, lighting system 10a may include detector 40 described in Embodiment 1 and controller 33a may change the color tone of the illumination light depending on the outdoor temperature obtained via detector 40. For example, when the outdoor temperature is lower than a predetermined value, controller 33a may cause (adjust) light source 31 to emit illumination light in a warm color, and when the outdoor temperature is higher than a predetermined value, controller 33a may cause (adjust) light source 31 to emit illumination light in a cool color.

As described above, with lighting system 10a according to this embodiment, controller 33a causes light source 31 to emit illumination light predetermined as stage lighting, based on at least the attribute information.

With this, stage lighting is performed based on the attribute information stored in RF tag 22a attached to the object, whereby the presentation of the product is enhanced to facilitate sales.

Moreover, in this embodiment, the object is a garment and the attribute information includes at least information indicating a season for which wearing the garment is suitable. Controller 33a causes light source 31 to emit the illumination light in a color predetermined as a cool color when the attribute information includes information indicating summer as the season. Controller 33a causes light source 31 to emit the illumination light in a color predetermined as a warm color when the attribute information includes information indicating winter as the season. Note that the attribute information is not limited to information indicating a season; the attribute information may be, for example, information indicating the color and pattern of the garment.

With this, even when a displayed summer garment is replaced with a winter garment or vice versa, the garment can be illuminated with illumination light appropriate for enhancing the presentation of the garment without requiring manual labor.

Note that this embodiment describes lighting system 10a which illuminates a garment displayed in a store with stage lighting, but the object illuminated by the stage lighting is not limited to this example, and may be any object that attracts attention, such as a billboard, decoration, or food product. For example, for a spot light in a food market, in accordance with the attribute information stored in an RF tag attached to the food product, illumination light may be emitted in a color tone that accentuates the red color of tomatoes or apples or in a color tone that accentuates the green color of green leafy vegetables. With this, even if the food product being sold changes, a lighting environment suitable for the food product currently being sold can be automatically created.

Hereinbefore, the lighting system and lighting device according to the present disclosure have been described based on Embodiments 1, 2, and a variation, but the lighting system and lighting device are not limited to these embodiments and variation. Embodiments arrived at by a person of skill in the art making various modifications to the embodiments and the variation as well as embodiments realized by arbitrarily combining structural elements in the embodiments and the variation which do not depart from the essence of the present disclosure are included in the present disclosure.

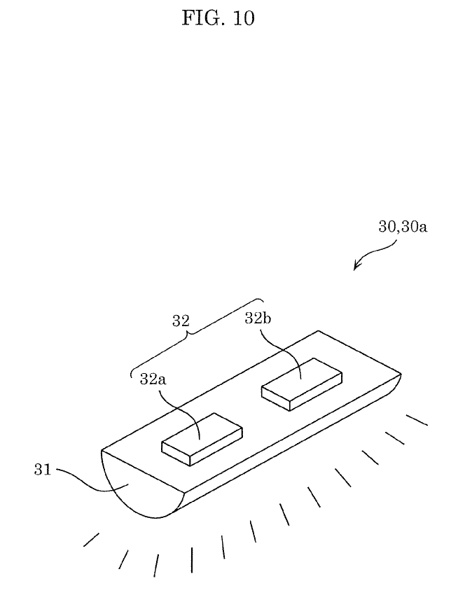

For example, in the above embodiments, as illustrated in the block diagrams of FIG. 1, FIG. 6, and FIG. 7, in the lighting device, light source 31 and communication circuit 32 (RF tag reader 32a and RF tag writer 32b) are aligned side by side. However, light source 31 and communication circuit 32 may be disposed so as to overlap, as illustrated in FIG. 10.

FIG. 10 is an external view of a lighting device (30, 30a) having a structure in which light source 31 and communication circuit 32 (RF tag reader 32a and RF tag writer 32b) overlap. Here, RF tag reader 32a and RF tag writer 32b are affixed to the top surface of light source 31, which is cylindrical in shape. The top surface of light source 31 is a flat metal plate, and a hole through which radio waves can pass is formed in the region in which RF tag reader 32a and RF tag writer 32b are affixed (not illustrated in the drawing). Note that the curved bottom surface of light source 31 is made of resin through which radio waves can pass.

With a lighting device structured as described above, the region in which illumination light is projected and the spatial region in which the RF tag reader and the RF tag writer can read and write are substantially the same. Therefore, it is possible to “visualize” the spatial region in which the RF tag reader and the RF tag writer can read and write, making it easier to install and manage the lighting system. Moreover, with a lighting device structured as described above, compared to when the RF tag reader and the RF tag writer are independently attached to, for example, a ceiling, the aesthetic appearance of the ceiling can be maintained.

Moreover, in the lighting system according to Embodiments 1 and 2, no control terminal, such as a remote control, for controlling the lighting device was expressly described, but the lighting system may include such a control terminal. In this case, information may be read and written from and to an RF tag via RF tag reader 32a and RF tag writer 32b in accordance with instruction from the control terminal. This makes it possible to check the attribute information stored in an RF tag via the control terminal while a plant is growing or a product is being displayed, and change the illumination light emitted by the lighting device to a more suitable illumination light by rewriting the attribute information.

Moreover, in Embodiments 1 and 2, the lighting device controls the dimming and color of the illumination light in accordance with, for example, the attribute information stored in a RF tag, but the lighting device may additionally or alternatively control the distribution (direction in which the light is projected) of the illumination light. This makes it possible to change the presentation in accordance with attributes of the object.

What is claimed is:

1. A lighting system that illuminates an object with illumination light, the lighting system comprising:
a radio frequency (RF) tag directly attached to the object or assigned to the object, the RF tag storing attribute information on the object; and
a lighting device that illuminates the object with the illumination light,
wherein the lighting device includes:
a light source that emits the illumination light;
a communication circuit including an RF tag reader that wirelessly reads the attribute information stored in the RF tag; and
a controller that controls at least one of dimming, a color, and an emission time of the illumination light emitted by the light source, based on the attribute information read from the RF tag by the RF tag reader.

2. The lighting system according to claim 1, wherein:
the communication circuit further includes an RF tag writer that wirelessly writes information to the RF tag, and
the controller obtains related information and writes the related information to the RF tag via the RF tag writer, the related information being information relating to a condition in which the object is placed.

3. The lighting system according to claim 2, wherein
the controller writes information specifying at least one of the dimming, the color, and the emission time of the illumination light illuminating the object to the RF tag as the related information.

4. The lighting system according to claim 2, further comprising
a detector that detects at least one of a temperature and a humidity of an environment in which the object is placed,
wherein the controller writes, as the related information, information indicating at least one of the temperature and the humidity detected by the detector to the RF tag.

5. The lighting system according to claim 2, wherein
the controller reads, via the RF tag reader, the attribute information and the related information stored in the RF tag, and based on the attribute information and the related information read from the RF tag, controls at least one of the dimming, the color, and the emission time of the illumination light emitted by the light source.

6. The lighting system according to claim 1, wherein
the controller causes the light source to emit one of illumination light predetermined as stage lighting and illumination light predetermined as biological reaction lighting, based on at least the attribute information.

7. The lighting system according to claim 1, further comprising: a storage that stores a plurality of predetermined lighting patterns, each of the plurality of predetermined lighting patterns being defined by a time variation of at least one of the dimming and the color,
wherein the controller causes the light source to emit the illumination light in one lighting pattern selected from the plurality of predetermined lighting patterns based on at least the attribute information.

8. The lighting system according to claim 1, further comprising
an environment conditioner that conditions an environment in which the object is placed,
wherein the controller further controls the environment conditioner.

9. The lighting system according to claim 1, wherein:
the object is a plant placed on a palette,
the RF tag is attached to the palette,
the attribute information includes at least information indicating a type of the plant, and
the controller controls the emission time of the illumination light and at least one of the dimming and the color of the illumination light emitted by the light source, based on the attribute information.

10. The lighting system according to claim 1, wherein:
the object is a garment,
the attribute information includes at least information indicating a season for which wearing the garment is suitable, and
the controller causes the light source to emit the illumination light in a color predetermined as a cool color when the attribute information includes information indicating summer as the season, and causes the light source to emit the illumination light in a color predetermined as a warm color when the attribute information includes information indicating winter as the season.

11. The lighting system according to claim 1, wherein the RF reader periodically performs an RF tag reading operation.

12. A lighting device that illuminates an object with illumination light, the lighting device comprising:
a light source that emits the illumination light;
a communication circuit including an RF tag reader that wirelessly reads attribute information stored in an RF tag assigned to the object; and
a controller that controls at least one of dimming, a color, and an emission time of the illumination light emitted by the light source, based on the attribute information read from the RF tag by the RF tag reader,
wherein the light source illuminates the object with the illumination light with the at least one of dimming, a color, and an emission time controlled by the controller.
